(19) United States
(12) Patent Application Publication
(10) Pub. No.: US 2007/0230291 A1
(43) Pub. Date: Oct. 4, 2007

(54) Optical disk magazine and optical disk recording/reproducing system

(75) Inventor: Tamotsu Iida, Ibaraki (JP)

Correspondence Address: BIRCH STEWART KOLASCH & BIRCH, PO BOX 747, FALLS CHURCH, VA, 22040-0747, US

(73) Assignee: HITACHI MAXELL, LTD.

(21) Appl. No.: 11/727,604

(22) Filed: Mar. 27, 2007

(30) Foreign Application Priority Data
Mar. 28, 2006 (JP) 2006-088628

(51) Int. Cl. G11B 21/08

(52) U.S. Cl. 369/30.38

(57) ABSTRACT

The present invention balances functions of an optical recording medium conflicting format-wise, such as effective placement of recording capacity and emphasis on random access performance. An optical disk in an optical disk format for random access which records management information and an optical disk for sequential recording are both stored in an optical disk magazine for storing multiple slim optical disks in the same magazine case.

### BACKGROUND OF THE INVENTION

The present invention relates to a magazine configuration for optical recording medium, an optical disk magazine system for recording and reproducing of the optical recording medium, in particular, efficiently driving the optical recording medium, and a recording and reproducing system.

In the field of an optical disk as an optical recording medium, there is increasing demand for a thinner substrate which is optically required and improvement in flatness of a substrate surface in conjunction with higher density of recording data. This is because, to cope with higher density of the recording data, it is necessary to increase a numeric aperture NA of an objective lens provided to an optical head, and if the NA of the object lens is increased, an allowable range of a substrate surface inclination becomes narrower so that it becomes more necessary to give consideration to crosstalk with an adjacent track.

However, the thinner substrate leads to reduction in rigidity of the optical disk itself, and the optical disk becomes easily deformable as a matter of course so that a problem such as wobbling is apt to occur on driving.

As for recording methods of the optical disk, there are a method of recording by irradiating a recording layer with a laser beam through a transparent substrate and a method of recording by providing a translucent cover layer on a surface of the recording layer opposed to the substrate and irradiating the recording layer with a laser beam via the cover layer. In the case of the latter method, it is possible to use an objective lens of a larger numeric aperture NA by designing the cover layer to be thinner with substrate thickness remaining unchanged from before. Therefore, it is possible to irradiate the optical disk with the laser beam focused without impairing the rigidity of the optical disk so as to perform higher-density recording. This type of optical disk is commercialized as the optical disk for recording a high-definition image (refer to WO 97/05607).

On the other hand, an effort is going on to realize higher density of the recording data by irradiating the recording layer with a laser beam through a transparent substrate in consideration of compatibility with conventional optical disks while keeping the thickness of a conventional substrate. In this case, uniformity of the substrates is further required, and attainment thereof is sought by improvement in the optical disk manufacturing technology.

In the present circumstances, each of the above-mentioned methods of improving recording density of the optical disk has advantages and disadvantages. Therefore, it is necessary to finish the substrate with characteristics of higher accuracy in view of further enhanced density of the recording data.

As for the optical disk, a higher data transfer rate is required in conjunction with the higher density of the recording data. In general, as capacity of handled data increases due to the higher density of the recording data, processing time accordingly increases. Therefore, the higher density of recording and a high-speed data transfer technology are inseparable issues. As for the higher data transfer rate of the optical disk, it is necessary to rotatively drive the optical disk at high speed for the sake of realization thereof. And high-speed rotary driving of the optical disk has been continuously performed to date.

Furthermore, the recording method for the data to be recorded is different depending on format of the optical disk. In the case of the optical disk, recording units of music data, image data, animation data or the like forming relatively long data rows are made as long as possible to expand an error correction processing range and thereby improve effective recording efficiency.

For instance, recording on a DVD-R, DVD-RW, DVD+R and DVD+RW and DVD-ROM is processed by adding an error correcting code ECC in each unit of 32 Kbytes. As for a 130-mm ISO (International Organization for Standardization) optical disk mainly designed for data recording of a computer, however, the error correcting code ECC is added in each unit of 1 or 2 Kbytes.

This difference is made by how the recording data unit is handled. In the case of a DVD, even if it is a short data file, it is the data file having voice, music, still images and moving images stored therein. Thus, there are hardly any data strings to be recorded by several Kbytes as in the case of data recording with a computer, but large data strings of several 100 Kbytes to several Mbytes or several Gbytes are handled in many cases.

In comparison, in the case of a recording apparatus connected to the computer, recording, deleting and reproducing operations are frequently performed. As for the units of data strings, they were conventionally processed in the units of 512 bytes to 2 Kbytes under normal conditions in terms of management of an OS (Operating System). To perform processing in these recording units, even in the case where the recording medium is the optical disk, the optical disk is required to have a sector capacity commensurate with the recording unit (to be more precise, 512 bytes to 2 Kbytes) as the recording medium. In this case, there is a possibility that a problem may arise in terms of reliability unless error processing is performed by a sector unit. For that reason, the error correcting code ECC is added to each of the sector units of the optical disk so that the entire sector size becomes larger by the portions taken by the error correcting code ECC.

For instance, a description will be given by taking a 130-mm optical disk cartridge specification ISO/IEC 15286 as an example. This specification defines it as an optical magnetic recording type optical disk having a recording capacity of 5.2 Gbytes on both sides. There are three sector sizes defined by this specification, i.e. user data sizes of 512 bytes, 1024 bytes and 2048 bytes respectively. It also defines the sector sizes including a management area of header addresses, the error correcting code ECC and the like as 826 bytes, 1416 bytes and 2635 bytes respectively. In this case, data efficiencies in the respective sector sizes are 63%, 72% and 78% respectively. If a comparison is made as to a specification ISO/IEC 16969 of the DVD+RW, a block size is 37,586 bytes while an ECC block size is 32 Kbytes so that the data efficiency thereof is about 87%.

From such a viewpoint, small and large sector sizes of the optical disk are known as a format of the optical disk which is selected and used as to each individual application. Thus, as things stand, the format of the optical disk has been different according to a driving method by which the optical disk is used from the viewpoint of access performance of the optical disk. To be more specific, an arrangement of the optical disk format has been different in accordance with a difference in the driving method such as CLV driving and CAV driving.

The CLV (Constant Linear Velocity) driving is a form capable of recording a maximum recording capacity on the disk, which constantly exerts control to keep data recording and reproducing linear speed constant. To be more precise, in the case of recording and/or reproducing information on a storage area on an inner circumference side of the optical disk, it is recorded by increasing the number of revolutions of the disk because a radial position of a recording location is small. In the case of recording and/or reproducing information on a storage area on an outer circumference side of the optical disk, it is recorded by reducing the number of revolutions of the disk because the radial position of the recording location is large. To be more specific, the number of revolutions of the optical disk is controlled correspondingly to a radial position from a disk center of the optical disk so as to keep linear speed for recording and reproduction constant irrespective of the radial position of the recording location in the storage area.

In comparison, the CAV (Constant Angular Velocity) driving is suited to control exerted by reducing time until a start of recording, and the number of revolutions of the disk is constantly fixed. For that reason, recording and reproducing positions are specified as the radial positions so that the recording and reproduction can be executed just by optical head movement and rotational latency.

For that reason, in the case of the CLV driving, there was a problem concerning data access that it required time until the number of revolutions of the optical disk settled to a predetermined number of revolutions corresponding to a radial position of access data and the position for recording on the optical disk could not be specified so that the data access thereof took time compared to the case of the CAV driving. For this reason, it was desired, even in the case of the CLV driving, to be capable of recording and reproduction by specifying the position for recording on the optical disk as in the case of the CAV driving from the viewpoint of speeding up the data access. Under the circumstances, there was necessity of a format of the optical disk for balancing the CAV driving with improved efficiency of the sector sizes. And it is a DVD-RAM that has met the requirement by sacrificing rewriting efficiency.

The DVD-RAM has data efficiency of a DVD format improved while securing random access. The DVD-RAM realizes the data efficiency in an ECC block size of 32 Kbytes, and so the recording, reproduction and rewriting must be performed in the ECC block size of 32 Kbytes. Furthermore, the block is further divided into the sector size of 2 Kbytes to allow rewriting to be performed in the units of 2 Kbytes while performing the recording and reproduction by including other remaining sector portions of the block. Thus, it has the specification which sacrifices the rewriting efficiency. To improve its access performance, the DVD-RAM has the format including a header configuration aligned in the radial direction of the optical disk. To be more specific, the DVD-RAM has the format which is an environment also usable for a computer, and is developed as an optical disk of good recording efficiency and high access performance.

Under the same DVD specification, uses of the DVDs are different according to the kind of DVD. The DVD-RAM is an optical disk suitable for recording of management information including file index information, and its rewriting durability is also secured. While the DVD-RW and the DVD+RW are rewritable optical disks, they are in the CLV driving format and cannot have the recording positions specified on the disk as previously described. For that reason, they have a drawback that erasure needs to be performed on the entire disk and it is not possible to erase or record at only a specific location of the disk as in the case of the DVD-RAM. The DVD-R or the DVD+R is a write-once type optical disk, and is suitable for application recording in which recording capacity is important because it is in the CLV driving format. A method of updating the management information by using the DVD-R or the DVD+R is proposed and realized. However, it is not suitable for an application to which access performance is important because its access performance is significantly reduced. For instance, multi-session recording and packet write technique both perform recording by sacrificing the recording capacity.

As a result of this, the DVD-RAM has an advantage that it is highly reliable and information is easily rewritable in comparison to other kinds of DVDs. Therefore, in many cases, a system was constructed by using the DVD-RAM as a recording medium for a server system in which a large capacity and fast access performance like a server were required.

### BRIEF SUMMARY OF THE INVENTION

For constructing a server of great volume system, particularly for recording a great amount of data, it is insufficient for effectively arranging recording data that DVD-RAM is used as the recording medium, and an optical recording medium having a format enabling the recording data to be efficiently arranged and to be randomly accessed with high efficiency is required. However, there is a problem of that the format of the optical recording medium cannot be made optimum in accordance with the data to be recorded in each recording region so that the recording data is efficiently arranged and randomly accessed with high efficiency.

When DVD-RAM is used as the recording medium without the arrangement of the recording data in high efficiency, a process for producing DVD-RAM is complicated so that DVD-RAM is more expensive in comparison with the other kinds of optical recording medium to necessarily increase a cost of the system.

The invention solves this problem, and an object of the invention is to provide an optical disk magazine and a recording/reproducing system, in which both of the efficient arrangement of the recording data and the random accessibility with high efficiency not obtainable in the format of the optical recording medium are obtained to drive efficiently the optical recording medium.

For solving the problem, the invention is characterized by that a thin optical disk for recording only management (administration) data (for example, a file name, a file address, a file produced and/or revised date, an alternative address of a part of file, or the like, or, and so forth) of recorded information with high random accessibility and another optical disk for only substance data of recorded information, which substance data has long data raw per each recording unit are contained in a common optical disk magazine so that the management (administration) data of recorded information and the substance data of recorded information can be recorded on respective ones of the thin optical disks having respective recording/reproducing formats optimum for respective recording purposes.

According to this, an optical disk magazine system of the invention in which a plurality of the thin optical disks (discrete with respect to each other, that is, separable from each other) is contained by the common magazine, is characterized in that in the magazine, one of the thin optical disks as a thin optical disk for recording management (administration) data of recorded information with a recording/reproducing format of high random accessibility, and the other one of the thin optical disks as another thin optical disk for recording substance data of recorded information with another recording/reproducing format for long data raw per each recording unit, are contained.

When data to be recorded is the management data of recorded information which needs the high random accessibility, the thin optical disk having the recording/reproducing format of high random accessibility is used, and when data to be recorded is the substance data of recorded information as archive data to be stored, the thin optical disk having the recording/reproducing format for recording the long data raw per each recording unit is used. Incidentally, the thin optical disk having the recording/reproducing format of high random accessibility is, for example, DVD-RAM, and the thin optical disk having the recording/reproducing format for recording the long data raw per each recording unit is, for example, DVD-R. The thin optical disk is an optical disk including a substrate having a thickness less than 0.6 mm as a standard value of DVD.

Further, the invention for solving the problem is characterized in that the management data of recorded information to be recorded and reproduced frequently is recorded on one of the thin optical disks contained by the common magazine of the magazine system, which one has the high random accessibility, and the substance data of recorded information is recorded on the other one of the thin optical disks, which other one has the recording/reproducing format for recording the long data raw per each recording unit.

Therefore, the optical disk recording/reproducing system of the invention in which data is recorded in the optical disk magazine system having the common magazine containing therein the plurality of the thin optical disks or data is reproduced from the plurality of the thin optical disks in the optical disk magazine system, is characterized by the thin optical disk contained in the magazine and having the recording/reproducing format of high random accessibility to record the management data, the other thin optical disk contained in the magazine and having the recording/reproducing format for recording the long data raw per each recording unit as the substance data, a management data recording/reproducing means for recording onto the thin optical disk for recording the management data the management data for recording/reproducing the substance data and reproducing the management data, and a substance data recording/reproducing means for recording onto the thin optical disk for recording the substance data the substance data managed by the management data.

Therefore, the management data of recorded information to be recorded with the high random accessibility is recorded by the management data recording/reproducing means onto the thin optical disk contained by the magazine and having the recording/reproducing format of high random accessibility, the substance data of recorded information to be recorded as the archive data to be stored is recorded by the substance data recording/reproducing means onto the thin optical disk contained by the magazine and having the recording/reproducing format suitable for recording the long data raw per each recording unit as the substance data, and the common magazine contains the thin optical disks having respectively the recording/reproducing formats different from each other so that the information is recorded integrally in the optical disk magazine system while satisfying both of the efficient arrangement of the recorded volume and the high random accessibility which are difficult to be concomitant with respect to each other.

In other words, according to the invention, the information to be recorded onto the optical recording medium is divided to the management data and the main or substance data related to the management data, and the management data and the main or substance data are recorded onto the respective thin optical disks having respectively the recording/reproducing formats different from each other to satisfy the respective recording purposes different from each other in the magazine.

In this case, the recording/reproducing format of high random accessibility may be a recording/reproducing format of magneto-optic disk for small sector size. Further, drive devices for driving the optical recording mediums are used to correspond to the recording/reproducing formats respectively.

According to the invention, the plurality of the thin optical disks are contained by the common magazine to enable each of the optical disks to be made thin while a mechanical strength of the optical disk magazine is prevented from being decreased, and an amount of the information per unit cubic volume is increased.

Further, according to the invention, the plurality of the thin optical disks whose recording/reproducing formats are different from each other are contained by the common magazine to satisfy both of the efficient arrangement of the recorded information and the high random accessibility which cannot be concomitant with respect to each other in the format, so that the optical recording mediums can be driven efficiently and the optical recording mediums with the high random accessibility and the great recorded volume is obtained.

More concretely, the management data of recorded information in which a volume of recording data unit is smaller in comparison with the substance data of recorded information is recorded in the thin optical disks of formats for respective using purposes in the common magazine so that the management data of recorded information which is firstly read or recorded for accessing and needs to be rewritten for each change of the recorded information can be functionally optimized for recording.

### BRIEF DESCRIPTION OF THE SEVERAL VIEWS OF THE DRAWINGS

FIG. 1 is a perspective view of an optical disk magazine according to an embodiment of the present invention.

FIG. 2 is an explanatory diagram of an example of a slim optical disk in a recording and reproducing format having good random access performance.

FIG. 3 is a block diagram of an embodiment of an optical disk magazine system according to the present invention.

### DETAILED DESCRIPTION OF THE INVENTION

Hereunder, a concrete description will be given by using the drawings as to embodiments of an optical disk magazine system and a recording and reproducing system of the present invention.

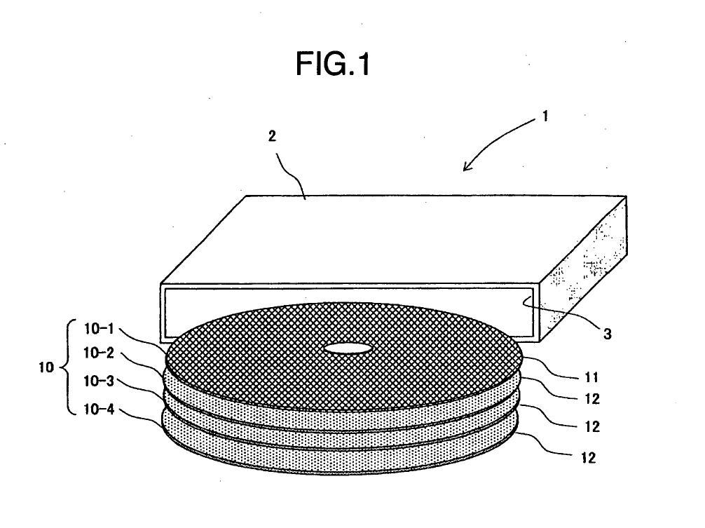

FIG. 1 is a perspective view of an optical disk magazine according to an embodiment of the present invention.

In FIG. 1, an optical disk magazine 1 comprises a magazine case 2 and multiple slim optical disks 10 stored inside the magazine case 2.

Although not shown in FIG. 1, an opening 3 of the magazine case 2 has a cover (not shown) or the like detachably provided thereon to prevent the slim optical disks 10 from falling. The optical disk magazine 1 normally has the opening 3 of the magazine case 2 blocked by the cover when not mounted on a recording and reproducing system described later. When mounted on the recording and reproducing system, the cover is opened so that a desired slim optical disk 10 can be taken out from inside the magazine case 2 via the opening 3 of the magazine case 2.

In the shown example, four slim optical disks 10-1 to 10-4 are stored as the slim optical disks 10 inside the magazine case 2.

The four slim optical disks 10-1 to 10-4 (stacked with a distance between adjacent ones thereof in a thickness direction of each of the disks) have physical formats aligned in a disk radial direction to allow random access. They are roughly divided into slim optical disks 11 as subjects of CAV driving in a recording and reproducing format capable of detecting addresses with the physical formats even when moved among tracks during revolution and slim optical disks 12 as subjects of CLV driving in a recording and reproducing format with a large sector or block size and a high implementation efficiency.

For instance, a DVD-RAM falls under a concrete example of the former slim optical disk 11 in the recording and reproducing format capable of random access in this case. Other than the DVD-RAM, a concrete example of the slim optical disk 11 may be a disk of the recording and reproducing format such as a magnetic optical disk defined by the ISO.

In comparison, for instance, the DVD-R, DVD+R, DVD-RW and DVD+RW fall under concrete examples of the latter slim optical disk 12 in the recording and reproducing format with a large sector or block size and high implementation efficiency. In particular, in the case of using a write-once type optical disk having storage stability and a tampering prevention effect as an archive file, usability is improved including higher reliability on updating by collaboration with the slim optical disk 11 having good random access performance.

In the case of the optical disk magazine 1 shown in FIG. 1, it has a configuration including the slim optical disk 10-1 as the slim optical disk 11 in the recording and reproducing format capable of random access and also including the slim optical disks 10-2 to 10-4 as the slim optical disks 12 in the recording and reproducing format with high implementation efficiency.

In this case, as for the slim optical disks 10-2 to 10-4 as the slim optical disks 12 in the recording and reproducing format with high implementation efficiency of the optical disk magazine 1, all of them do not have to be the disks in the same recording and reproducing format. Even mutually among the slim optical disks 10-2 to 10-4, the above-mentioned DVD-R, DVD+R, DVD-RW and DVD+RW may be mixed and various reproduction only ROM disks incapable of recording may further be mixed as long as they are the slim optical disks 12 in the recording and reproducing format with high implementation efficiency.

The total number of the slim optical disks 10 stored in the optical disk magazine 1 and breakdown of the numbers of the slim optical disks 11 in the recording and reproducing format capable of random access and the slim optical disks 12 in the recording and reproducing format with high implementation efficiency are not limited to the shown example if at least one each of the slim optical disks 11 and 12 in the recording and reproducing formats thereof is stored.

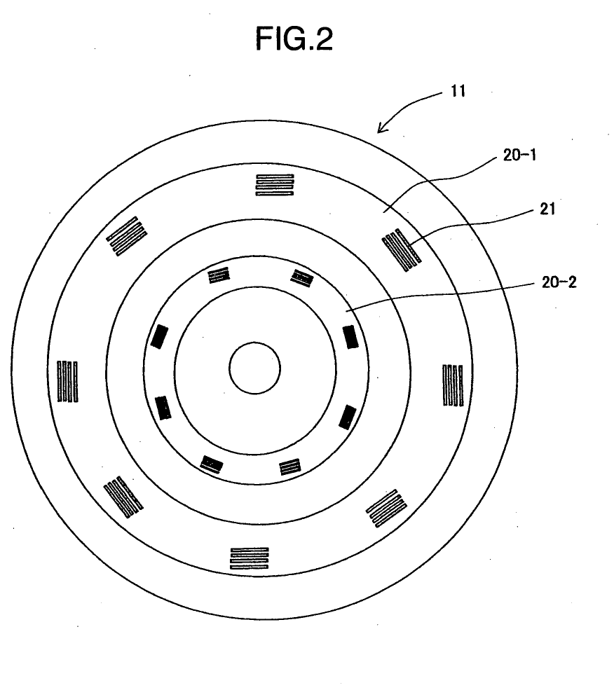

FIG. 2 is an explanatory diagram of an example of the above-mentioned slim optical disk in the recording and reproducing format having good random access performance.

FIG. 2 shows how header placement differs in each zone 20 as format placement of the slim optical disk 11 by taking a zone 20-1 and a zone 20-2 as examples.

Header portions 21 for recording address information are radially placed inside the zones 20-1 and 20-2 of the slim optical disk 11. Here, it is shown that the header portions 21 inside the zone 20-1 are placed at a constant rate in a circumferential direction of the zone 20-1 and are dividing the zone 20-1 evenly into blocks in the circumferential direction, i.e. a disk rotation direction.

Dividing the zones 20-1 and 20-2 into the blocks by radial positions of the slim optical disk 11 is a measure for increasing the recording capacity of the entire disk. There are the cases where the numbers of headers in the divided zones 20-1 and 20-2 are different though not shown in FIG. 2.

It is possible, by using the slim optical disk 11 configured as shown in FIG. 2, to specify a recording location in each of the blocks of the divided zones 20-1 and 20-2 based on the header portions 21 respectively so as to increase the recording capacity of the entire disk.

As described above, multiple slim optical disks 10 are stored in the same magazine case 2, where the multiple slim optical disks 10 include at least one each of the slim optical disk 11 in the recording and reproducing format capable of random access and the slim optical disk 12 in the recording and reproducing format with high implementation efficiency. By making such an optical disk magazine 1, it is possible, when recording external recording information on the optical disk magazine 1 for instance, to record management data of the recording information on the slim optical disk 11 in the recording and reproducing format capable of random access and record information data of the recording information on the slim optical disk 12 in the recording and reproducing format with high implementation efficiency so as to configure a convenient recording medium system which exploits characteristics, i.e. advantages of each of the recording and reproducing formats.

In this case, it suffices if the slim optical disks 10 stored in the optical disk magazine 1 can be regarded as one in terms of operation, and they do not have to be constantly integrated.

The above-mentioned differences between the recording and reproducing formats are based on a difference in storage efficiency due to differences in the alignment, sector length and block length between the CAV driving and the CLV driving. For instance, the combination of a DVD-RAM and a DVD-R in one optical disk magazine 1 is a typical example thereof.

Next, an optical disk recording and reproducing system to which the optical disk magazine system configured as described above is applied will be described with reference to the drawings.

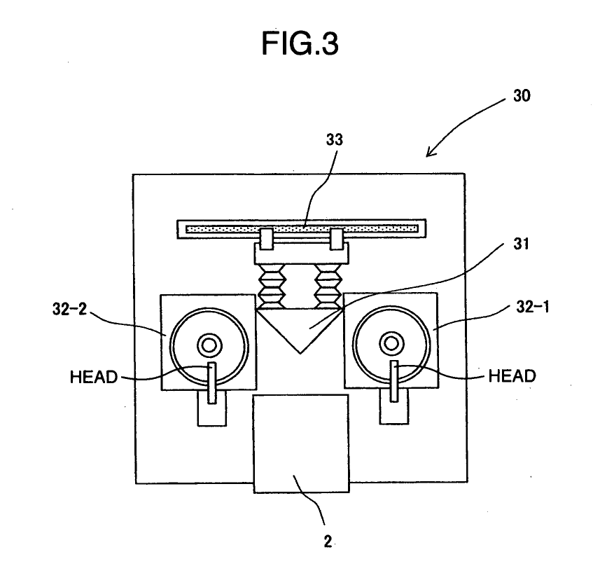

FIG. 3 is a block diagram of an embodiment of the optical disk recording and reproducing system according to the present invention.

In FIG. 3, as for an optical disk recording and reproducing system 30 of this embodiment, once the optical disk magazine 1 shown in FIG. 1 is inserted into the system and the opening 3 of the magazine case 2 is opened, a robotic arm 31 is inserted into the magazine case 2 in order to take out the slim optical disk 11 in the recording and reproducing format capable of random access and having the management data on the recording information stored in the optical disk magazine 1 recorded thereon from the magazine case 2.

In this case, if the optical disk magazine 1 has a configuration in which the slim optical disk 11 is constantly placed from one side of a disk axis line direction inside the magazine case 2, the optical disk recording and reproducing system 30 can easily take out the slim optical disk 11 in the recording and reproducing format capable of random access and having the management data of the recording information recorded thereon from the optical disk magazine 1 by using the robotic arm 31.

Next, the optical disk recording and reproducing system 30 mounts the slim optical disk 11 which was taken out on a disk information recording and reproducing spindle of a drive system 32-1 as one of multiple drive systems 32-1, 32-2 provided to the optical disk recording and reproducing system 30 by means of a magnet chuck or the like. On that basis, the optical disk recording and reproducing system 30 performs the CAV driving to a drive mechanism to which the disk information recording and reproducing spindle of the drive systems 32-1 is connected.

As previously described, the slim optical disk 11 has the management data on the recording information recorded thereon, which is corresponding to the information data of the recording information recorded on all or a predetermined one of the slim optical disks 12 in the recording and reproducing format with high implementation efficiency inside the optical disk magazine 1. Therefore, the optical disk recording and reproducing system 30 performs reproduction in the recording and reproducing format capable of random access with the drive system 32-1 for performing the CAV driving so as to locate the management data of the target recording information.

As a result of this, if there is the management data of the target recording information, the optical disk recording and reproducing system 30 takes out the slim optical disk 12 in the recording and reproducing format with high implementation efficiency and having the information data of the target recording information recorded thereon from the same optical disk magazine 1 based on data reproduction contents thereof by using the robotic arm 31 to mount it on the disk information recording and reproducing spindle of the other drive system 32-2 of the multiple drive systems 32-1, 32-2 by means of the magnet chuck or the like. On that basis, the optical disk recording and reproducing system 30 performs the CLV driving to the drive mechanism to which the disk information recording and reproducing spindle of the drive system 32-2 is connected. In the shown example, the robotic arm 31 can be moved between the drive systems 32-1 and 32-2 by a robotic arm movement mechanism 33.

The optical disk recording and reproducing system 30 reproduces the information data of the target recording information recorded on the slim optical disk 12 in the recording and reproducing format with high implementation efficiency which was taken out, based on the management data of the target recording information which was reproduced earlier.

In this case, the one drive system 32-1 functions as management data recording and reproducing means for detecting an address in a physical format aligned in the disk radial direction from the mounted slim optical disk 11 and reproducing the management data of the recording information recorded in the recording and reproducing format having good random access performance. The other drive system 32-2 functions as information data recording and reproducing means for reproducing the information data of the recording information recorded in the recording and reproducing format suitable for recording of sequential data of a large sector or block size and a long record length from the mounted slim optical disk 12 based on the management data of the recording information which was reproduced earlier by the one drive system 32-1 as the management data recording and reproducing means.

According to such an optical disk recording and reproducing system 30 of this embodiment, the management data of the recording information can be promptly reproduced and obtained by using the random access with the drive system 32-1 for performing the CAV driving as the management data recording and reproducing means. And the information data of the recording information can be promptly and collectively reproduced and obtained by the drive system 32-2 for performing the CLV driving as the information data recording and reproducing means.

In the case of recording information on the optical disk magazine 1, the optical disk recording and reproducing system 30 creates the management data and the information data on the recording information. And it records the management data of the recording information on the slim optical disk 11 in the recording and reproducing format capable of random access with the drive system 32-1 for performing the CAV driving as the management data recording and reproducing means. It also records the information data of the recording information on the slim optical disk 12 in the recording and reproducing format suitable for recording of sequential data of a large sector or block size and a long record length with the drive system 32-2 for performing the CLV driving as the information data recording and reproducing means.

The optical disk recording and reproducing system 30 of this embodiment is configured as described above. However, it is not limited thereto. For instance, the management data recording and reproducing means and the information data recording and reproducing means may be configured by multi-disk drive systems respectively. Or, else, each of them may be configured by one multi-disk drive system.

1. An optical disk magazine comprising,
an optical disk for recording management data with a recording/reproducing format suitable for random access, and
another optical disk for recording substance data with another recording/reproducing format suitable for great data unit of the substance data.

2. An optical disk recording/reproducing system comprising,
an optical disk for recording management data with a recording/reproducing format suitable for random access,
another optical disk for recording substance data with another recording/reproducing format suitable for great data unit of the substance data,
a management data recording/reproducing device for recording the management data onto the optical disk and reproducing the management data from the optical disk, and
a substance data recording/reproducing device for recording the substance data onto the another optical disk and reproducing the substance data from the another optical disk in accordance with the management data.

3. The optical disk magazine according to claim 1, wherein the recording/reproducing format of the optical disk includes physical format aligned along a radial direction of the optical disk.

4. The optical disk magazine according to claim 1, wherein the another disk is capable of being driven at a constant linear velocity to record the substance data onto the another optical disk.

5. An optical disk magazine usable in a reproducing device, comprising,
a first optical disk for recording therein an information,
a second optical disk for recording therein a management data for identifying the information on the first optical disk and indicating an address of the information on the first optical disk, the first and second optical disks being discrete with respect to each other, and
a magazine case for containing therein the first and second optical disks stacked in a thickness direction of each of the first and second optical disks so that the first and second optical disks aligned in the thickness direction by the magazine case are capable of being mounted onto the reproducing device all at once and being taken out of the reproducing device all at once.

6. The optical disk magazine according to claim 5, wherein the management data is capable of being recorded in the first optical disk as well as the second optical disk.

7. The optical disk magazine according to claim 6, wherein the management data is obtainable from the second optical disk before accessing the management data recorded on the first optical disk.

8. The optical disk magazine according to claim 5, wherein the second optical disk has a recording area for recording thereon the management data, and an address of the recording area on the second optical disk is defined by a radial alignment position of the recording area on the second optical disk.

9. The optical disk magazine according to claim 5, wherein the second optical disk includes an ordering information for ordering the reproducing device to drive rotationally the second optical disk at a constant angular velocity to restrain a rotational velocity of the second optical disk from being changed in accordance with a variation of reproducing head radial position at which the management data is read out from the second optical disk by a reproducing head of the reproducing device.

10. The optical disk magazine according to claim 5, wherein the management data includes an ordering data for ordering the reproducing device to drive rotationally the first optical disk at a constant linear velocity to increase a rotational velocity of the first optical disk in accordance with a decrease of a distance between a rotational axis of the first optical axis and a reproducing head radial position at which the information is read out from the first optical disk by a reproducing head of the reproducing device.

11. The optical disk magazine according to claim 5, wherein the magazine comprises a plurality of the first optical disks discrete with respect to each other, and the second optical disk is capable of recording therein the management data for identifying the information on each of the first optical disks and indicating the address of the information on each of the first optical disks.

12. The optical disk magazine according to claim 5, wherein the first optical disk includes a plurality of files of the information, and the management data for identifying each of the files on the first optical disk and indicating the address of each of the files on the first optical disk are capable of being recorded in the second optical disk so that the management data for identifying each of the files on the first optical disk and indicating the address of each of the files on the first optical disk are obtainable from the second optical disk before accessing all of the files on the first optical disk.

13. An optical disk recording/reproducing system comprising,
a first optical disk for recording therein an information,
a second optical disk for recording therein a management data for identifying the information on the first optical disk and indicating an address of the information on the first optical disk, the first and second optical disks being discrete with respect to each other,
a recording/reproducing device for recording the information into the first optical disk and reproducing the information from the first optical disk, and recording the management data into the second optical disk and reproducing the management data from the second optical disk, and
a magazine case for containing therein the first and second optical disks stacked in a thickness direction of each of the first and second optical disks so that the first and second optical disks aligned in the thickness direction by the magazine case are capable of being mounted onto the reproducing device all at once and being taken out of the reproducing device all at once.
